(19) United States
(12) Patent Application Publication
(10) Pub. No.: US 2026/0319852 A1
(43) Pub. Date: Oct. 15, 2026

(54) METHOD FOR CONTROLLING THE RESOURCE ALLOCATION OF SOFTWARE COMPONENTS IN A VEHICLE

(71) Applicant: Robert Bosch GmbH, Stuttgart (DE)

(72) Inventors: Andreas Heyl, Weil Der Stadt (DE); Holger Niemann, Ludwigsburg (DE)

(21) Appl. No.: 19/636,376

(22) Filed: Apr. 1, 2026

(30) Foreign Application Priority Data
Apr. 11, 2025 (DE) 10 2025 114 327.7

(51) Int. Cl. G06F 9/50; G05B 13/02

(52) U.S. Cl. CPC G06F 9/5027; G05B 13/0265

(57) ABSTRACT

A method for controlling the resource allocation of software components in a vehicle, in particular a software-defined vehicle. The software components are assigned to predefined execution environments isolated from one another, in particular trust zones, having different security levels. The assignment of the software components to the execution environments is dynamically adapted to changed operating conditions of the vehicle.

### FIELD

The present disclosure relates to a method and a control unit for controlling the resource allocation of software components in a vehicle, in particular a software-defined vehicle, a computer program and a computer-readable storage medium.

### BACKGROUND INFORMATION

Software-defined vehicles (SDVs) are characterized by an increasing number of software components that are responsible for various vehicle functions. These components must be assigned securely and efficiently to the available hardware resources in order to ensure the functionality and the safety of the vehicle.

Conventional approaches to software assignment are often based on manual configuration or simple rule sets. However, these methods are neither sufficiently scalable nor flexible enough to meet the increasing safety requirements and the dynamic nature of software development in SDVs. Static assignment tables or deployment-specific configuration scripts cannot adequately take into account changing conditions in the vehicle, such as, e.g., software updates over-the-air or new threat situations.

### SUMMARY

The present disclosure provides a method, a control unit for a vehicle, a computer program, and a computer-readable medium.

The present disclosure relates to a method for controlling the resource allocation of software components in a vehicle. In particular, the method is suitable for use in software-defined vehicles (SDVs). Here, software components are understood to mean executable programs, program libraries or other software modules that perform specific functions within the vehicle, such as, for example, control of the drive, the braking system or the infotainment. According to an example embodiment, the software components are assigned to execution environments isolated from one another. These execution environments can, for example, be implemented as trust zones, but in any case provide protection by isolation. Trust zones are regions shielded from one another that provide a secure execution space for software components. The isolation prevents a security incident in one execution environment from impairing other regions of the system. The execution environments are provided with different security levels in order to take into account the protection requirement of the respective software components. A safety-critical component, such as the control of the braking system, would be assigned to an execution environment having a higher security level than a less critical component, for example the control of the windshield wipers. In the example method, the assignment of the software components to the execution environments is dynamically adapted to changed operating conditions of the vehicle. Operating conditions comprise all internal and external factors that influence operation of the vehicle. Examples of changed operating conditions are software updates, new threat situations due to malware or hacker attacks, or changes in the system load due to the activation or deactivation of vehicle functions.

By dynamically adapting the assignment to the operating conditions, an efficient and secure use of the resources in the vehicle is achieved. Thus, for example, upon recognition of a new malware threat, safety-critical software components can be moved into more highly secured execution environments in order to minimize the risk of an attack. At the same time, less critical components can be moved, as needed, into execution environments having a lower security level in order to free up resources. Furthermore, the dynamic assignment enables a flexible response to software updates. New or updated software components can be assigned, based on their safety criticality and the current operating conditions, to the suitable execution environments without requiring a manual reconfiguration of the system.

This method offers a plurality of technical advantages. An essential advantage is the improved safety of the vehicle. By dynamically assigning software components to trust zones having different security levels and adapting to changed threat situations, the risk of cyberattacks and their effects on safety-critical functions is minimized. At the same time, the efficiency of the system is increased by the flexible resource allocation. Resources are allocated according to demand, which improves the performance of the vehicle and optimizes energy consumption. In addition, the automation of the assignment process reduces development effort and improves the maintainability of the system.

Further advantages can be found in the disclosure herein.

In a preferred example embodiment, it is provided that the assignment of the software components is based on an extended Threat Analysis and Risk Assessment (TARA). TARA is an established method for systematically identifying and assessing security risks. In the context of this disclosure, an extended TARA is used which, in addition to the safety criticality, also takes into account at least one attack vector for each software component.

The safety criticality of a software component indicates what effects malfunction of this component may have on the safety of the vehicle. It is classified, for example, according to the Automotive Safety Integrity Level (ASIL) or the ISO/SAE AWI PAS 8475 standard. The ASIL ranges from A (lowest criticality) to D (highest criticality). A component having ASIL D, such as, e.g., the brake software, thus has the highest safety requirements. ISO/SAE AWI PAS 8475 defines the criticality levels negligible, moderate, major and severe.

An attack vector describes a possible path by which a software component may be attacked. Examples of attack vectors are physical access to the vehicle, local access via a diagnostic interface, access from adjacent systems within the vehicle or network access via the Internet.

By taking into account both the safety criticality and the attack vectors in the extended TARA, the assignment of the software components to the execution environments can be designed more precisely and more securely. A component having high safety criticality and an attack vector via the Internet would, for example, be assigned to an execution environment having the highest security level. By contrast, a component having low safety criticality and only a local attack vector can be executed in an execution environment having a lower security level.

This approach increases the safety of the vehicle, since safety-critical components are better protected against attacks. At the same time, it enables more efficient resource use, since not all components need to be executed in the most strongly secured execution environments.

In a further preferred example embodiment of the method according to the present disclosure, the extended TARA uses data from a safety specification (also known in part as a safety manifest or safety manual) of the software component and from a description of the system architecture of the vehicle. The safety specification supplies detailed information regarding the safety criticality of the relevant software component. It typically contains information regarding the ASIL level, possible failure scenarios, and the implemented security mechanisms. By using this information, the extended TARA can precisely assess the safety criticality of the component.

In a preferred example embodiment of the present disclosure, the extended TARA takes into account, for each software component, at least one attack vector from the categories of physical access, local access, adjacent access and network access. These categories cover a broad spectrum of potential attacks and enable a comprehensive risk assessment. Physical access means that an attacker has direct physical access to the vehicle. This could comprise, for example, manipulating hardware components or connecting external devices to diagnostic interfaces. Local access exists if an attacker has access to the internal network of the vehicle, e.g., via a Bluetooth or USB connection. Adjacent access describes attacks from systems located in immediate proximity to the vehicle, e.g., via wireless connections such as WLAN or Bluetooth. One example would be an attack from a manipulated smartphone connected to the vehicle. Network access relates to attacks via the Internet or other external networks. This is particularly relevant for vehicles having an Internet connection, which is used, for example, for over-the-air updates or online services. Taking these attack vectors into account in the extended TARA enables a differentiated risk assessment for each software component. A component that is reachable via the Internet (network access) is classified, for example, as more vulnerable than a component that can only be attacked via physical access. As a result, the assignment of the components to the execution environments can be optimally adapted to the respective safety requirements. A component having a high risk due to network access would be placed in a more strongly isolated trust zone than a component having a low risk. This increases the security of the overall system by minimizing the probability and the effects of successful attacks.

In a preferred example embodiment of the method according to the present disclosure, the assignment of the software components to the execution environments is carried out automatically by means of a rule-based algorithm. This algorithm is based on the results of the extended TARA, which, as already described above, assesses the safety criticality and the attack vectors of each software component. The rule-based algorithm uses predefined rules in order to determine the assignment to the execution environments. An example of such a rule could be: “If the safety criticality is ASIL D and network access exists, then assign the component to the trust zone having the highest security level.” By using a rule-based algorithm, the assignment becomes objective and reproducible. The manual effort for configuration is eliminated, and human errors are avoided. The automation also enables a rapid and flexible response to changed operating conditions. If, for example, a new attack vector is discovered, the algorithm can automatically adapt the assignment of the affected components without requiring manual intervention. This increases the security and the efficiency of the system.

In a preferred example embodiment, the dynamic adaptation of the assignment is supported by means of one or more machine-learning models. Machine learning enables the system to learn from experience and adapt to changed conditions without being explicitly programmed. In the context of this disclosure, machine-learning models can be used to improve the accuracy and efficiency of the assignment of software components to trust zones. In particular, the machine-learning models can be trained on the results of the extended TARA. Thus, for example, a model can be trained in order to predict the probability of a successful attack via a specific attack vector. This prediction can then be integrated into the rule-based algorithm in order to optimize the assignment of the components to the trust zones. Another model could be trained in order to ascertain the optimal resource distribution between the trust zones based on the current system load and the safety requirements. By using machine learning, the system can independently recognize patterns and connections in the data and adapt its decisions accordingly. This enables a finer granularity and a faster response to changed conditions in comparison with a purely rule-based system. As a result, the safety of the vehicle is further increased and resource use is optimized.

In a preferred example embodiment of the method according to the present disclosure, the assignment of the software components is adapted in real time to changed operating conditions of the vehicle. This means that the system can respond within the shortest possible time to changes that require an adaptation of the assignment. Examples of such changes are the occurrence of new threats, changes in the system load or software updates.

The real-time capability is enabled by the combination of the rule-based algorithm with the machine-learning models and an efficient implementation of a trust zone manager (TZM). The TZM continuously monitors the relevant operating conditions of the vehicle and, as needed, initiates the recalculation of the assignment. By using machine learning, the system can respond quickly to new, unknown threats by analyzing the existing data and recognizing patterns.

The real-time adaptation of the assignment is decisive for the security and stability of the vehicle. It enables the system to adapt dynamically to changed conditions and minimize the effects of attacks or malfunctions. In the event of an attack, the system can, for example, quickly move affected components into a more secure trust zone in order to prevent the spread of the malware. In the case of a software update, new components can immediately be assigned to the suitable execution environment without requiring manual intervention.

Thus, the real-time capability of the system contributes substantially to increasing the safety, the availability and the flexibility of the software-defined vehicle.

In a preferred example embodiment of the method according to the present disclosure, the execution environments comprise hardware-based trust zones. Hardware-based trust zones provide a particularly high degree of security, since they are based on hardware mechanisms that cannot be manipulated by software. One example of such a technology is ARM TrustZone, a widely used security architecture for embedded systems. ARM TrustZone divides the hardware resources of the processor into two separate regions: a secure region (Secure World) and a normal region (Normal World). Software components that are executed in the Secure World are protected against attacks from the Normal World. By using hardware-based trust zones, the security of the software components is additionally increased, in particular for safety-critical functions that have a high protection requirement. Even if malware is successfully executed in the Normal World, it cannot access the data and functions protected in the Secure World. This increases the resistance of the system to attacks and contributes to the safety of the vehicle. Other hardware-based security architectures can also be used, provided that they ensure secure isolation between the execution environments.

In a preferred example embodiment of the method, the assignments of the software components are logged in a tamper-proof log. This increases the transparency and traceability of the assignment process and contributes to improving system security. Each event that triggers a change of the assignment of a software component to a trust zone is recorded in this log. For this purpose, this comprises, for example, the initial assignment upon system start, changes due to software updates, responses to recognized threats or adaptations to changed system loads.

One example of such a tamper-proof log is a blockchain. Blockchains are decentralized, cryptographically secured databases that are characterized by their high resistance to forgery. Each entry in the blockchain is provided with a timestamp and a unique signature and is chained to the preceding entries. This makes it practically impossible to subsequently change or delete entries without this being noticed.

Logging the assignments in a blockchain offers a plurality of advantages. First, the traceability of the assignment decisions is ensured. In the event of a security incident, based on the log, it can be traced which component was executed in which trust zone at which point in time. This helps with analyzing the incident and identifying the cause. Second, the tamper-proof logging increases trust in the integrity of the system. Since the assignments cannot be manipulated unnoticed, the risk of sabotage or unauthorized changes is minimized. Third, blockchain technology can also be used for audit purposes in order to document compliance with security guidelines and standards.

In a preferred example embodiment of the method according to the present disclosure, the assignment of the software components to the execution environments is controlled by a trust zone manager (TZM). The TZM is a central component responsible for the execution of the entire assignment process. It undertakes the following tasks: first, performing the extended TARA for each software component. The TZM collects the necessary information from the safety manual of the component and the system architecture description. Second, calculating the trust score for each component based on the results of the TARA. Third, assigning the components to the trust zones based on the calculated trust score and the predefined rules or threshold values. Fourth, dynamically adapting the assignment in real time based on the information supplied by the IDS and system health monitoring and taking into account the machine-learning models. Fifth, logging the assignment decisions in the tamper-proof log.

By centralizing these tasks in the TZM, the complexity of the assignment process is reduced and the consistency of the assignment decisions is ensured. The TZM functions as a central contact point for all security-relevant information and controls the assignment of the software components to the trust zones in order to ensure the security and stability of the vehicle.

In a preferred example embodiment of the method according to the present disclosure, the assignment of the software components to the execution environments is controlled by a trust zone manager (TZM). The TZM is a dedicated component that undertakes the entire logic and control for the dynamic assignment of software components to the trust zones. It is, so to speak, the “brain” of the system and ensures that the software components always run in the respectively safest and most efficient execution environment. The TZM performs the extended Threat Analysis and Risk Assessment (TARA). For this purpose, it uses the information from the safety manual of each software component and the description of the system architecture of the vehicle. Based on the results of the TARA, the TZM calculates, for each component, a trust score that reflects the safety criticality and the potential attack risks. Based on this trust score and the predefined rules of the rule-based algorithm, the TZM assigns the software components to the corresponding trust zones.

For dynamic adaptation to changed operating conditions, the TZM can be connected to various information sources, such as, for example, an intrusion detection system (IDS) and/or system health monitoring. The IDS monitors data traffic in the vehicle network and recognizes suspicious activities that could indicate an attack. System health monitoring, by contrast, monitors the state of the system, e.g., the utilization of the resources or the occurrence of errors. This information helps the TZM to assess the current security situation and the system state and to adapt the assignment of the software components accordingly. Thus, for example, in the event of an attack recognized by the IDS, the TZM can move affected components into a more secure trust zone or, in the case of high system utilization reported by system health monitoring, free up resources by moving components into less secure trust zones. However, even without this additional information, the TZM is capable of performing the assignment based on the results of the extended TARA and the predefined rules.

Finally, the TZM optionally logs all assignment decisions in a tamper-proof log in order to ensure the traceability and transparency of the process. By centralizing the control in the TZM, an efficient and secure resource allocation in the vehicle is enabled.

The aforementioned advantages also apply in a corresponding manner to a control unit for a vehicle that is configured to perform one of the above-described methods. This control unit, which can in particular be configured as a trust zone manager (TZM), is a specialized hardware and/or software component that is integrated into the vehicle system. It can be provided, for example, as a separate microcontroller, as a process running on an existing control device or as a combination of both. Via dedicated interfaces, the control unit communicates with other components of the vehicle in order to obtain information regarding the operating conditions, the security situation and the system architecture. For example, it can be connected to the intrusion detection system (IDS), the system health monitoring and the software update module. The control unit has access to the safety manual of the software components and the description of the system architecture. The control unit according to the present disclosure executes the method by performing the extended TARA, calculating the trust scores, carrying out the assignment of the software components to the trust zones and dynamically adapting this assignment to the changed operating conditions.

Optionally, the control unit can contain a hardware security module (HSM) in order to securely perform cryptographic operations, such as the calculation and verification of digital signatures. This increases the security of the system by preventing manipulation of the assignment data and the software components. Optionally, the control unit can also implement a redundancy mechanism in order to ensure the availability of the system in the event of a fault. In the event of a failure of the primary control unit, a redundant unit can take over the control and continue the assignment of the software components. Optionally, the control unit can provide an interface to an external security management system in order to enable the remote configuration and monitoring of the TZM. This allows, for example, the central management of the security guidelines for a vehicle fleet. Optionally, the control unit may also use more powerful machine-learning models that are executed on specialized hardware, such as, e.g., an FPGA or an AI accelerator. This enables the processing of large data quantities and the application of more complex algorithms in order to further improve the accuracy and efficiency of the assignment.

The subject matter of the present disclosure is also a computer program or computer program product, comprising instructions which, when the computer program is executed by a computer or by the control unit according to one of the aforementioned embodiments, cause the computer or the control unit to execute at least one or all steps of the method according to one of the aforementioned embodiments. The computer program or computer program product can be stored on a machine-readable, in particular non-volatile carrier or storage medium such as a semiconductor memory, a hard disk storage or an optical storage.

The subject matter of the present disclosure is also a computer-readable medium on which the above-described computer program is stored.

The term “computer-readable medium” can be understood as a physical medium that stores information in a form that can be read and processed by a computer or another electronic device. Such a medium can, for example, be a CD-ROM, a DVD, a USB stick, a hard disk or another storage medium that stores digital data. The medium can comprise both magnetic and optical storage media and can be present in various formats, such as, for example, a file, a program or an operating system. The medium can also be used as part of a larger system or a larger device, such as, for example, as part of a computer or a control unit in a vehicle. In any case, the computer-readable medium enables the transfer of information between different electronic devices and execution of programs or applications on these devices.

### BRIEF DESCRIPTION OF THE DRAWINGS

Exemplary embodiments of the present disclosure are illustrated schematically in the drawings and explained in more detail in the following description. The same reference signs are used for the elements which are shown in the various figures and act similarly, wherein a repeated description of the elements is dispensed with.

FIG. 1 is a schematic representation of a method, a control unit, a vehicle, a computer program and a storage medium according to an exemplary embodiment.

FIG. 2 is a schematic representation for visualizing the present disclosure according to an exemplary embodiment.

### DETAILED DESCRIPTION OF EXAMPLE EMBODIMENTS

As already set forth above, the present disclosure provides a method, a control unit, a computer program and a storage medium that make it possible to dynamically and securely adapt the resource allocation of software components in a vehicle, in particular a software-defined vehicle, to changed operating conditions.

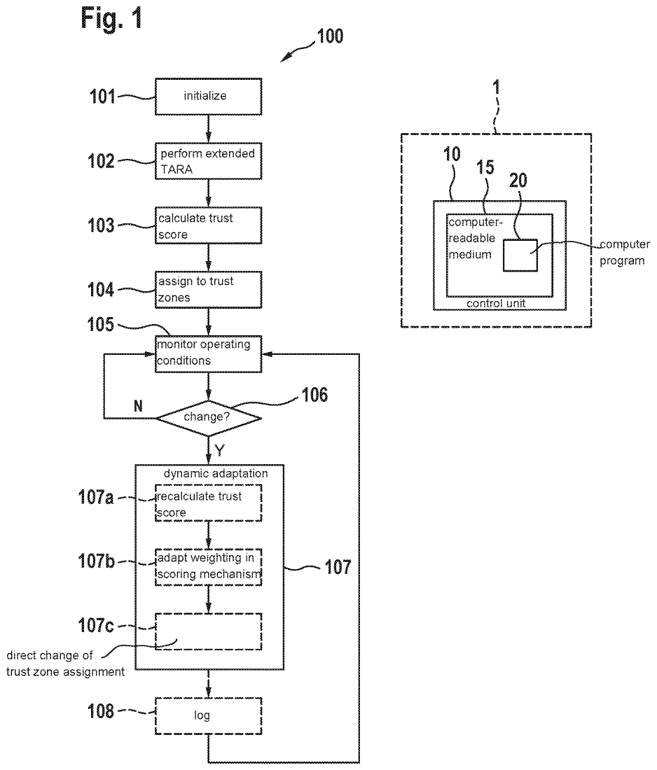

FIG. 1 shows, on the left side, a flowchart of the method 100 according to the present disclosure for the dynamic assignment of software components to trust zones in a vehicle, which may, for example, be executed by a control unit 10 as shown on the right side. The control unit 10 can be integrated in a vehicle 1 and is also referred to below as a trust zone manager (TZM). In a preferred embodiment, a computer program 20, which is stored on a computer-readable medium 15, runs on the control unit 10 and causes it to execute one of the steps or all steps of the method 100 described below.

The method 100 begins with a step of initialization 101. Here, the necessary data structures and parameters are initialized, including the component inventory. The component inventory comprises all software and hardware components present in the vehicle, their functions and interfaces. This serves as the basis for the later analysis of the dependencies and communication paths.

In the following step 102, an extended TARA is performed, which serves for the comprehensive assessment of the security risks of each individual software component in the vehicle. The extended TARA goes beyond conventional risk analyses by taking into account not only the safety criticality of the component, but also the potential attack paths and the system architecture.

The safety criticality of a software component is initially ascertained based on the Automotive Safety Integrity Level (ASIL). The ASIL is a standard of the automotive industry that defines the safety requirements for safety-relevant systems. It ranges from ASIL A (lowest criticality) to ASIL D (highest criticality). The ASIL level of a component is typically documented in the safety manual of the component. Alternatively, the ASIL level can also be extracted directly from the header of the component, for example by a declarative method in which the ASIL level is stored as meta-information in the code. This method enables an automated evaluation of the safety criticality.

After the determination of the safety criticality, the potential attack vectors for the relevant component are identified. An attack vector describes a possible path by which an attacker could compromise the component. In order to identify the attack vectors, the system architecture of the vehicle is analyzed in detail. This analysis comprises the following aspects:
Communication paths: The communication paths between the individual software components are examined. Here, an analysis is performed as to which data are exchanged between the components and which security mechanisms are used to protect the communication. Examples of such security mechanisms are encryption, authentication and access control. Weak points in communication security may represent attack vectors.
Trust boundaries: Trust boundaries define boundaries between regions having different trust levels. For example, there could be a trust boundary between the infotainment system and the safety-critical braking system. The extended TARA analyzes the trust boundaries in the system and the associated security mechanisms, such as, e.g., firewalls. Weak points in the trust boundaries may enable attackers to advance from a less trusted region into a more trusted region.
Resource allocation: The resource allocation, i.e., the allocation of resources such as CPU time and storage space to the software components, is examined. Insufficient resource allocation may lead to denial-of-service attacks in which a component is rendered nonfunctional by overload. The extended TARA identifies potential denial-of-service risks and assesses their effects on the safety of the vehicle.
Dependencies: The dependencies between the software components and external libraries or services are analyzed. If a component is dependent on an insecure library, this may represent a weak point that can be exploited by attackers. The extended TARA identifies such dependencies and assesses the risk associated therewith.
Update mechanisms: The security of the update mechanisms, in particular of over-the-air (OTA) updates, is assessed. OTA updates enable the updating of the software in the vehicle via a wireless connection. Insecure update mechanisms may be used by attackers to install manipulated software in the vehicle. The extended TARA examines the security mechanisms used, such as, e.g., digital signatures and secure bootloaders, in order to ensure the integrity and authenticity of the updates.

The results of the extended TARA, i.e., the safety criticality and the identified attack vectors, are documented for each software component and serve as the basis for calculation of the trust score in the next step of the method.

In the following step 103, a calculation of the trust score is carried out, which qualifies the findings obtained in the extended TARA regarding the security risks of each software component. Here, a numerical value, the trust score, is calculated for each component. This score represents the security risk of the component and serves as the basis for the later assignment to the trust zones.

The calculation of the trust score is based on the safety criticality of the component (ASIL level) and the attack vectors identified in the extended TARA. A weighted scoring mechanism is used. For example, the following table can be used to assess the safety criticality (ASIL) and the attack vectors and to calculate the trust score:

| ASIL level | Points |
|---|---|
| D | 10 |
| C | 7 |
| B | 4 |
| A | 1 |
| QM | 0 |

| Attack vector | Points |
|---|---|
| Physical | 5 |
| Local | 4 |
| Adjacent | 3 |
| Network | 2 |

The trust score of a component then results from the sum of the points for the ASIL level and the relevant attack vectors. For example, a component having ASIL level D and the attack vectors “Physical” and “Network” would have a trust score of 10+5+2=17.

Based on the trust score, the component is assigned to a trust zone class. Exemplary definitions of the trust zones based on safety criticality and attack vectors are:
TZ_High_PhysLocNet: For components having high safety requirements (ASIL D/C) and physical, local or network attack vectors.
TZ_Medium_LocAdj: For components having medium safety requirements (ASIL B/A) and local or adjacent attack vectors.
TZ_Low_NetProt: For components having low safety requirements (QM) and network attacks or those that merely need to be protected against undesired access.

The following table shows, by way of example, the assignment of some components:

| Software | | Attack | | |
|---|---|---|---|---|
| component | ASIL | vectors | Trust zone | Reason |
| Brake | D | Physical, | TZ_High_PhysLocNet | High safety |
| assistant | | local | | requirements |
| Engine | C | Local, | TZ_High_PhysLocNet | High safety |
| control | | adjacent | | requirements |
| Airbag | B | Local | TZ_Medium_LocAdj | Medium |
| control | | | | safety |
| | | | | requirements |

Optionally, in this step, a machine-learning algorithm can also be used in order to refine the calculation of the trust score and adapt it to the specific circumstances of the vehicle. The machine-learning algorithm can learn, based on training data, how the various factors (ASIL level, attack vectors, further context information) influence the actual security risk of a component. These training data can be obtained, for example, from simulations, test drives or empirical values from earlier vehicle models.

The machine-learning algorithm can be integrated into the calculation of the trust score in various ways. For example, it can dynamically adapt the weightings for the ASIL levels and attack vectors or incorporate additional factors into the calculation that are not detected by the rule-based system. By using machine learning, the trust score can be designed to be more accurate and more meaningful, and the assignment of the components to the trust zones can be further optimized. However, the use of machine learning is optional, and the method can also be used effectively without this extension.

The calculated trust score is stored for each software component and serves in the next step as the basis for the assignment to the trust zones.

In the following step 104, an assignment to trust zones is carried out. Here, for each software component, based on the previously calculated trust score, the suitable execution environment in the form of a trust zone is selected. This step ensures that safety-critical components are executed in correspondingly protected environments, whereas less critical components can be placed in environments having lower security precautions in order to save resources.

The assignment is carried out based on predefined threshold values for the trust score. These threshold values define the boundaries between the different trust zone classes. For example, a threshold value of 15 points could be specified, above which components are assigned to the trust zone TZ_High_PhysLocNet. Components having a trust score between 8 and 14 points could be assigned to the trust zone TZ_Medium_LocAdj, and components having a trust score below 8 points could be assigned to the trust zone TZ_Low_NetProt.

In order to simplify and automate the assignment, a lookup table can be used. This table contains the different trust zones and the associated threshold values for the trust score. For each trust score, the TZM can look up the corresponding trust zone in the table. This lookup table can be adapted by the vehicle manufacturer to the specific safety requirements of the vehicle.

The trust zones TZ_High_PhysLocNet, TZ_Medium_LocAdj, and TZ_Low_NetProt mentioned by way of example in the previous step offer different security levels. TZ_High_PhysLocNet is provided for components having high safety requirements that must be protected against physical attacks and against attacks via the local network or the Internet. TZ_Medium_LocAdj offers medium protection for components that must be protected against local and adjacent attacks. TZ_Low_NetProt offers basic protection against network attacks and is suitable for components having low safety requirements.

After the trust zone for a component has been selected, the assignment is implemented in the system. This means that the execution environment of the component is actually changed. There are various possibilities for achieving this:
Moving into containers: Software components can be executed in containers (e.g., Docker, WebAssembly). Containers provide an isolated execution environment and make it possible to move components easily between different trust zones. The TZM can implement the assignment by moving the relevant component into a container that is assigned to the desired trust zone.
Switching the hardware configuration: Hardware-based trust zones, such as, e.g., ARM TrustZone, provide separate execution environments at the hardware level. The TZM can implement the assignment by changing the hardware configuration and moving the component into the corresponding hardware region.
Configuration of virtualization software: When virtualization software is used, the TZM can implement the assignment by changing the configuration of the virtual machine in which the component is executed. For example, it can change the network connection of the virtual machine or restrict access to specific hardware resources.

The concrete implementation of the assignment depends on the system architecture used and the available technologies. It is important that the assignment is carried out efficiently and reliably and that the desired security level is ensured.

In the following step 105, monitoring of the operating conditions is carried out, which is a continuous process that runs in parallel with the execution of the software components in the vehicle. This step is essential for the dynamic adaptation of the trust zone assignment, since it supplies the TZM with the necessary information regarding the current state of the vehicle. Due to the constant monitoring, the TZM can respond promptly to changes and adapt the assignment of the components to the current circumstances.

The monitoring comprises various parameters that are relevant to the security and stability of the vehicle. These include:
System load: The system load provides information regarding the utilization of the resources of the vehicle, such as, e.g., processor, memory and network bandwidth. A high system load can impair the performance of the vehicle and lead to instabilities. Therefore, it is important to continuously monitor the system load and, as needed, adapt the assignment of the software components in order to avoid overload. For example, less critical components could be moved into trust zones having a lower security level in order to free up resources for critical components.
Occurrence of errors: The monitoring also comprises the recognition of errors in the software components and the hardware of the vehicle. Errors may lead to unexpected behavior and security vulnerabilities. Therefore, it is important to recognize errors quickly and take corresponding measures. For example, the TZM can, in the event of an error, move the affected component into a more secure trust zone or deactivate it in order to prevent the spread of the error.
Network activity: The network activity of the vehicle, both in the internal network and in communication with external networks, is monitored. Suspicious network activities, such as, e.g., unusually high data traffic or connection attempts from unknown sources, may indicate an attack. In such cases, the TZM can adapt the assignment of the components in order to protect the vehicle against attacks. For example, it could tighten the firewall rules or restrict network access of specific components.
Environmental conditions: Optionally, the environmental conditions of the vehicle, such as, e.g., temperature, humidity or GPS position, can also be monitored. This information may be relevant for specific application cases. For example, the assignment of the components could be adapted to the current GPS position in order to restrict access to specific functions in specific regions.

The operating conditions are monitored by various sensors, diagnostic modules, and the intrusion detection system (IDS). Sensors detect physical variables such as temperature and acceleration. Diagnostic modules monitor the state of the hardware and software and report errors. The IDS analyzes the network traffic and recognizes suspicious activities. The data collected by these components are transmitted to the TZM, which uses the data for the dynamic adaptation of the trust zone assignment.

The continuous monitoring of the operating conditions makes it possible for the TZM to respond quickly and efficiently to changes in the vehicle and to ensure the security and stability of the system.

In the following step 106, a check for a change of the operating conditions is carried out. Here, it is determined whether the dynamic adaptation of the trust zone assignment is required. In this step, the TZM analyzes the information collected in step 105 regarding the operating conditions of the vehicle and checks whether significant changes are present that require an adaptation of the assignment.

The check for relevant changes can be carried out in various ways:
Exceedance of threshold values: Threshold values can be defined for many parameters, such as, e.g., system load, CPU utilization or network latency. When a parameter exceeds or falls below a threshold value, this is interpreted as a relevant change. For example, a threshold value for CPU utilization of 90% could be specified. If the CPU utilization exceeds this value, this indicates a high system load and triggers a dynamic adaptation of the assignment.
Recognition of anomalies: The TZM can also use methods for anomaly recognition in order to identify unusual patterns in the operating data. These methods may be based on statistical methods or machine learning. For example, a machine-learning model could be trained to recognize normal network behavior. If the model detects a deviation from normal behavior, e.g., unusually high data traffic to a specific IP address, this is interpreted as an anomaly and a dynamic adaptation is triggered.
Receipt of event messages from the IDS: The intrusion detection system (IDS) monitors the network traffic for suspicious activities that could indicate an attack. If the IDS recognizes a possible attack, it sends an event message to the TZM. Receipt of such an event message is interpreted as a relevant change and triggers a dynamic adaptation of the assignment. For example, the IDS could recognize a port scan, in which an attacker attempts to find open ports in the system. In this case, the TZM would adapt the assignment of the components in order to protect the attackable ports.

If no relevant change of the operating conditions is determined in step 106, the method returns to step 105 and continues the continuous monitoring of the operating conditions. The assignment of the software components to the trust zones remains unchanged in this case.

If relevant changes of the operating conditions are recognized in step 106, a step 107 of dynamic adaptation is carried out. This step enables the adaptation of the trust zone assignment in real time to the current circumstances in the vehicle. The dynamic adaptation ensures that the software components always run in the respectively optimal execution environment in order to ensure the security and stability of the system.

The type of adaptation depends on the type of recognized change. There are various possibilities for dynamically adapting the assignment of the components to the trust zones:
Recalculation of the trust score 107a: If the safety criticality of a component or the relevant attack vectors change, the trust score can be recalculated. This takes place taking into account the new information obtained by monitoring the operating conditions. For example, the discovery of a new weak point in a component may result in the trust score being increased and the component being moved into a more secure trust zone.
Adaptation of the weightings in the scoring mechanism 107b: The weightings assigned to the ASIL levels and the attack vectors in the scoring mechanism can be dynamically adapted. This makes it possible to adapt the importance of the various factors to the current situation. For example, the weighting of network attacks could be increased if the IDS determines increased network activity. This adaptation of the weightings can be carried out by a machine-learning model that learns, based on training data, how the weightings should be optimally set.
Direct change of the trust zone assignment 107c: In some cases, it may be necessary to change the trust zone assignment of a component directly, without recalculating the trust score. This may be the case, for example, if the IDS recognizes a concrete attack on a specific component. The TZM can then immediately move the affected component into a more secure trust zone in order to repel the attack.

The dynamic adaptation leads to an actual change of the execution environment of the affected components in the vehicle. This change can be carried out in real time, i.e., within the shortest possible time, in order to be able to respond quickly to changes. The concrete implementation of the change depends on the system architecture used. As described above in step 104, this can be carried out, for example, by moving the component into another container or by switching the hardware configuration of the trust zone.

Here are some concrete examples of the dynamic adaptation:
Recognition of an attack: If the IDS recognizes an attack on the brake control, the TZM moves the brake control from a trust zone having a medium security level into the trust zone having the highest security level (TZ_High_PhysLocNet). As a result, it is ensured that the brake control functions reliably even in the event of an attack.
High system load: When the system load exceeds a critical value, the TZM moves less critical components, such as, e.g., the control of the windshield wipers, from TZ_Medium_LocAdj into TZ_Low_NetProt. As a result, resources are freed up and made available for more critical components.

The dynamic adaptation makes it possible to ensure the security and stability of the vehicle even under changed operating conditions.

After the dynamic adaptation of the trust zone assignment in step 107, or directly after step 104 if no dynamic adaptation was required, logging can optionally be executed in step 108. In this step, the current assignment of the software components to the trust zones is recorded in a tamper-proof log. This logging offers traceability and makes it possible to subsequently check and analyze the assignment history. The logging comprises information such as the timestamp of the assignment, the unique identification of the software component, the assigned trust zone and optionally the calculated trust score of the component. In addition, optionally, the triggering event, e.g., a change of the operating conditions or a software update, and a reason for the assignment decision, e.g., “high system load” or “recognized attack,” can be logged. In order to ensure the integrity of the logging, a tamper-proof log is used. One example of such a log is a blockchain. Blockchains are decentralized, cryptographically secured databases that are characterized by their high resistance to forgery. Each entry in the blockchain is provided with a timestamp and a unique signature and is chained to the preceding entries. This makes it practically impossible to subsequently change or delete entries without this being noticed. As an alternative to a blockchain, other tamper-proof logging mechanisms can also be used, e.g., digital signatures or hash functions. It is important that the integrity and authenticity of the logged data are ensured. After the optional logging in step 108, or directly after step 107 if step 108 is not executed, the method can return to step 105. The method can thus run in a loop and dynamically adapt the assignment of the software components to the changing conditions in the vehicle. This continuous process ensures that the software components always run in the respectively safest and most efficient execution environment and that the security and stability of the system are ensured even under changed operating conditions. The optional steps are identified in the flowchart by dashed lines.

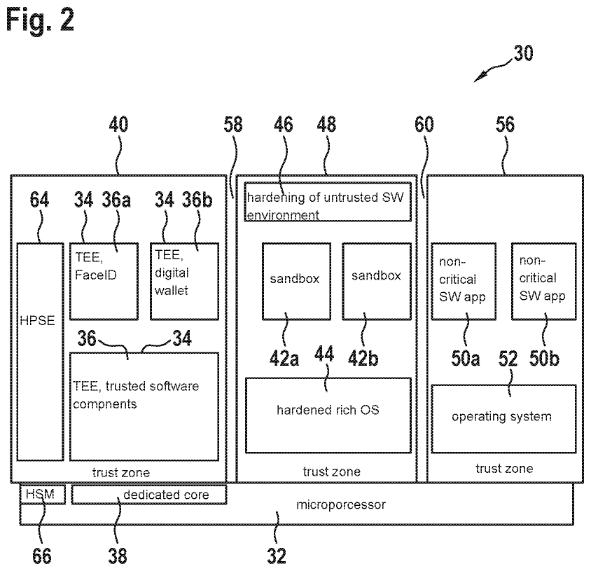

FIG. 2 shows an exemplary system architecture 30 of a vehicle having different trust zones 40, 48, 56, which implement the above-described method. The architecture 30 uses a combination of hardware-based and software-based security mechanisms in order to isolate and protect the software components according to their safety requirements. The entire architecture 30 is based on a microprocessor 32, the hardware of which is shown in the bottommost level. The trust zones 40, 48, 56 offer different security levels and enable the flexible and secure execution of software components having different safety requirements.

The first trust zone 40 comprises trusted execution environments (TEEs) 34 and offers the highest security level. It is isolated from the rest of the system by hardware mechanisms and ensures the secure execution of trusted software components 36 that meet the highest safety requirements, such as, e.g., safety-critical vehicle functions or cryptographic operations. Within the TEE 34, there is a “hardware protected security environment” (HPSE) 64, which offers an even higher degree of security. The HPSE 64 is supported by a hardware security module (HSM) 66 which securely executes cryptographic operations, such as, e.g., the verification of digital signatures, and thus ensures the integrity and confidentiality of the data processed in the HPSE 64. In the HPSE 64, particularly critical data and functions that must be protected against external attacks are processed. A dedicated core 38, which is referred to as a housekeeping core, is responsible for the management of the TEE 34 and the HPSE 64. Examples of software running in the TEE 34 are safety-critical applications such as FaceID 36a or a digital wallet 36b.

The second trust zone 48 offers a medium security level and comprises a “hardening of untrusted SW” environment 46 and two instances of a sandbox environment 42a, 42b.

The sandboxes 42a, 42b provide an isolated execution environment for software components that are not fully trusted. Due to the sandboxing technology, these components are prevented from accessing resources outside their sandbox or damaging the system. The sandboxes 42a, 42b are managed by a “hardened rich OS” 44, which provides additional security mechanisms. The “hardening of untrusted SW” environment 46 hardens untrusted software by security mechanisms such as secure containerization.

The third trust zone 56 offers the lowest security level and contains two instances 50a, 50b of “non-critical SW app.” These applications have lower safety requirements and run directly on an operating system 52, e.g., Android or Linux.

The communication between the trust zones 40, 48, 56 and the individual components is controlled by firewalls 58, 60 and other security mechanisms. The first firewall 58 protects the TEE 34 against unauthorized access. The second firewall 60 protects the communication in the second trust zone 48 and the third trust zone 56.

The trust zone manager (TZM) is responsible for the assignment of the software components to the trust zones and continuously monitors the system state and the threat situation in order to dynamically adapt the assignment. Although the TZM is not explicitly shown in the illustration, it controls the assignment of the components to the trust zones.

1-13. (canceled)

14. A method for controlling the resource allocation of software components in a software-defined vehicle, the method comprising:
assigning the software components to predefined execution environments isolated from one another in trust zones having different security levels; and
dynamically adapting the assignment of the software components to the execution environments to changed operating conditions of the vehicle.

15. The method according to claim 14, wherein the assigning of the software components is based on an extended Threat Analysis and Risk Assessment (TARA) that, in addition to safety criticality according to Automotive Safety Integrity Level (ASIL) and/or ISO/SAE AWI PAS 8475, takes into account at least one attack vector for each of the software components.

16. The method according to claim 15, wherein the extended TARA uses data from a safety specification of each software component and from a description of a system architecture of the vehicle.

17. The method according to claim 15, wherein the extended TARA takes into account, for each software component, at least one attack vector from categories of physical access, local access, adjacent access, and network access.

18. The method according to claim 15, wherein the assignment of the software components is carried out automatically using a rule-based algorithm that is based on results of the extended TARA.

19. The method according to claim 15, wherein the dynamic adaptation of the assignment is supported using one or more machine-learning models, wherein the one or more machine-learning models were trained on results of the extended TARA.

20. The method according to claim 14, wherein the assignment of the software components is adapted in real time to the changed operating conditions of the vehicle.

21. The method according to claim 14, wherein the execution environments include hardware-based trust zones.

22. The method according to claim 21, wherein the hardware-based trust zones include at least one ARM TrustZone.

23. The method according to claim 14, wherein the assignments of the software components are logged in a tamper-proof log.

24. The method according to claim 23, wherein the tamper-proof log is a blockchain.

25. The method according to claim 14, wherein the assignment of the software components to the execution environments is controlled by a trust zone manager.

26. A control unit for a software-defined vehicle configured to dynamically adapt an assignment of software components in the vehicle, to predefined execution environments isolated from one another in trust zones having different security levels, to changed operating conditions of the software-defined vehicle.

27. The control unit according to claim 26, wherein the control unit includes a trust zone manager.

28. A non-transitory computer-readable medium on which is stored a computer program for controlling the resource allocation of software components in a software-defined vehicle, the computer program, when executed by a control unit, causing the control unit to perform the following steps:
assigning the software components to predefined execution environments isolated from one another in trust zones having different security levels; and
dynamically adapting the assignment of the software components to the execution environments to changed operating conditions of the vehicle.
